(19) United States
(12) Patent Application Publication
(10) Pub. No.: US 2022/0358869 A1
(43) Pub. Date: Nov. 10, 2022

(54) BRIGHTNESS CONVERSION DATA BLOCKS

(71) Applicant: HEWLETT-PACKARD DEVELOPMENT COMPANY, L.P., Spring, TX (US)

(72) Inventor: Thong Thai, Spring, TX (US)

(73) Assignee: HEWLETT-PACKARD DEVELOPMENT COMPANY, L.P., Spring, TX (US)

(21) Appl. No.: 17/307,429

(22) Filed: May 4, 2021

(51) Int. Cl. G09G 3/20

(52) U.S. Cl. CPC G09G 3/2003; G09G 2320/0646; G09G 2320/064; G09G 2310/08; G09G 2360/144; G09G 2360/141

(57) ABSTRACT

An example electronic device may include a processor resource and aa memory resource with a set of instructions stored thereon that, when executed, cause the processor resource to retrieve a first brightness characteristic and a second brightness characteristic associated with the light source, associate the first brightness characteristic with a first nits level and the second brightness characteristic with a second nits level using a brightness conversion data block, determine a brightness control signal directly compatible with the light source, and cause the light source to operate via the brightness control signal.

### BACKGROUND

Compute devices are commonly used with peripheral devices and other compute devices to perform input processing and output functionality. For example, a desktop compute device may be coupled to by a keyboard, a computer mouse, and a display device to allow a user to interact with compute device using physical input and view the state of compute device using the display device. The computer device generally causes operation of a peripheral via an input/output (IO) port. For example, a video processor of a host device may send a video signal via a video output port to a display peripheral device to produce visual output. The host device generally manages profiles and other data regarding configurations of connected peripherals.

### BRIEF DESCRIPTION OF THE DRAWINGS

FIGS. 1-3 are block diagrams depicting example brightness conversion systems.

FIGS. 4A & 4B depict example components useable to implement example brightness conversion systems.

FIGS. 5 and 6 depict example display metadata structures.

FIGS. 7-11 are flow diagrams depicting example methods of causing operation of a display device.

### DETAILED DESCRIPTION

In the following description and figures, some example implementations of apparatus, brightness conversion systems, and/or methods of causing operation of a display device are described.

As used herein, an electronic device refers to any apparatus with an electronic component, such as a component that uses electrical signals to communicate and/or activate an operation. Electronic devices utilize electrical signals to provide power to the device and activate circuitry. An example electronic device is a compute system. A compute system is a combination of circuitry and executable instructions to perform an operation (e.g., a processor resource to process a computation). An example compute system includes a host device with an input/output (IO) bus for managing connections with peripheral devices. A host device is a general computer (or a specialized computer) with a processor resource and a memory resource with instructions stored thereon that, when executed by the processor resource, cause operation of an operating system (OS).

A peripheral device is an electronic device capable of being connected to and communicating with the host device. For example, the peripheral device may be a human interface device (HID) to allow a user to input information to be processed by the host device, such as generation of signals corresponding to information input from interaction with a user. Example peripheral devices include display devices, print apparatus, hubs, switches, routers, keyboards, computer mice, scanners, lighting devices, power banks, and the like. In this manner, peripheral devices generally extend the input and output capabilities of the general compute device to include functionalities, new or improved, in comparison to the integrated components of the general compute device.

In examples described herein, a display device may be a device to present content visually. Example display devices may include a screen such as a liquid crystal display (LCD) panel, an organic light-emitting diode (OLED) panel, a micro light emitting diode (pLED), or other display technology. In some examples, a display device may also include circuitry to operate the screen, such as a monitor scaler or other video processor.

A display device may present (e.g., displays) an image on a panel using a data source to determine a color to display for every pixel on the panel. The source image data may include color data according to a color space such as red, green, and blue (RGB) channel data. Colors displayed by a panel are dependent on the color characteristics of the display panel. For LCD panels, color characteristic information may include spectral output of the backlight and the tone of the color filters applied on the top of the grayscale liquid crystals. These characteristics differ from panel to panel, resulting in colors often looking very different on one computer monitor or television as compared to another. The display memory may be used to store multiple color calibration profiles that correspond to a plurality of luminosity ranges or “display modes,” such as standard RGB (sRGB), high dynamic range (HDR), standard dynamic range (SDR), etc. These may be referred to as color presets when selected on the display device. For HDR, there may be a requirement to drive the panel at a specific nit level. This may be accomplished through a digital path where the source provides a direct nit level for the panel to achieve, as supported through the HDR timing controller (TCON).

Operating system (OS) features may leverage nit-based brightness, such as for adaptive color and enhanced adaptive brightness response. However, the actual nit-based function in the display panel is performed by the TCON (for an integrated panel) or scaler circuitry (for external display and some panels for all-in-one computer devices). Thus, nit-based brightness functionality is limited to what the display panel can support and such nit-based brightness functions may not be supported on a panel with analog brightness control (e.g., pulse-width modulation (PWM) brightness control or direct voltage brightness control), such as is the case with SDR panels. In such an example, the OS function calls that are based on nit level may not be useable with SDR panels.

Various examples described below relate to supporting nits-based function calls on electronic devices that do not directly support nits-based function calls. By generating modified display metadata, the brightness conversion system may allow a display device to operate as if the display natively supports nits-based function calls, such as those used by HDR panels, even on systems that generally don't support nits function calls, such as SDR panels. The modified display metadata may provide conversion data between nits and natively supported signal protocols of the display device.

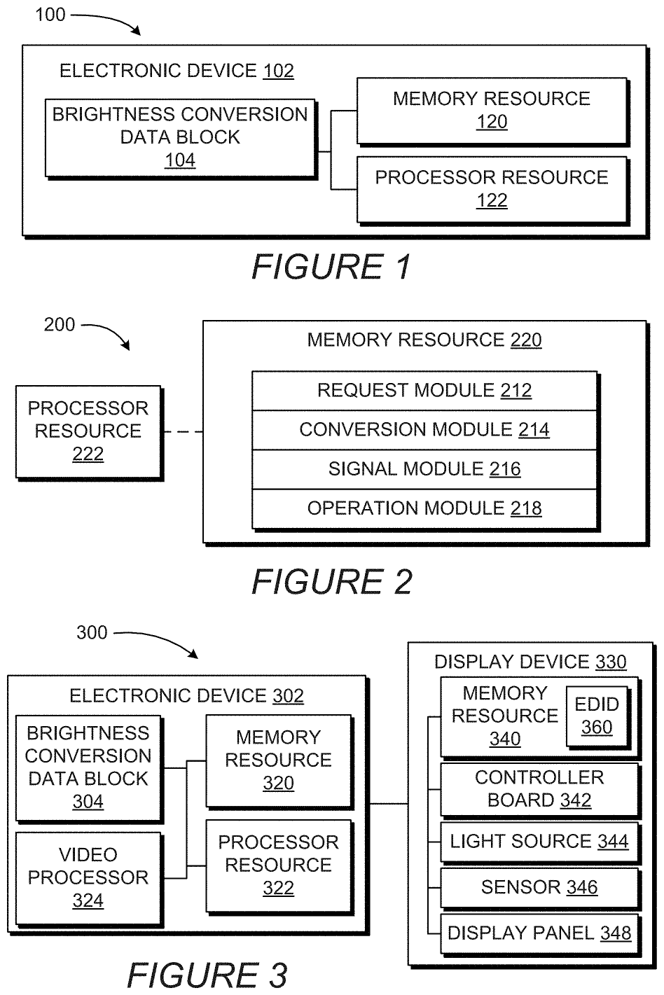

FIGS. 1-3 are block diagrams depicting example brightness conversion systems 100, 200, and 300. Referring to FIG. 1, the example brightness conversion system 100 of FIG. 1 generally includes an electronic device 102 with a brightness conversion data block 104, a memory resource 120, and a processor resource 122.

The brightness conversion data block 104 represents data, executable instructions, or a combination of data and executable instructions to cause the processor resource 122 to generate an association between a brightness characteristic of a display device and an operation level of a light source in nits. The brightness conversion data block 104 may include reference nit-to-non-nit values, such as a base or minimum nit level with its corresponding analog value (e.g., minimum a PWM value or direct voltage value) and a maximum nit level with its corresponding analog value or (e.g., a maximum PWM value or direct voltage value), and relationship factor describing the relationship between the reference values (e.g., a curve or slope factor between the reference values). For example, the brightness conversion data block may be generated by the electronic device using a base nit level with a corresponding base PWM value or base voltage level value and an auxiliary nit level with a corresponding auxiliary PWM value or auxiliary voltage level value. Two reference values are an example, but any number of reference points may be used, where more reference points may provide for higher accuracy. Similarly, any number of relationship factors may be used. For another example, a PWM to nits output for SDR panels may be linear so a graphics processing unit (GPU) may use a default linear interpolation between the nit to PWM reference points or may use a curve or slope factor for interpolation if one is provided in the brightness conversion data block. For example, the brightness conversation data block is generated using a plurality of additional auxiliary nit levels and a relationship factor, where the relationship factor includes a curve factor adapted to a minimum range of PWM values and a maximum range of PWM values and a linear factor outside of the minimum range of PWM values and the maximum range of PWM values. In another example, an SDR panel's nit-to-PWM respond curve may be linear except for the very high end and low end of its brightness PWM range, therefore multiple curves or slopes may be described by the brightness conversion data block 104.

The brightness conversion data block 104 may be stored on memory resource 120 in addition to other data and executable instructions. In some examples, the electronic device 102 includes a controller with the brightness conversion data block 104 embedded therein. As used herein, a controller represents a combination of circuitry and executable instructions that represent a control program that, when executed by the circuitry, cause the electronic device to operate in accordance with the control program.

The memory resource 104 includes a set of executable instructions executable by the processor resource to retrieve a brightness characteristic associated with a light source, associate the brightness characteristics with a nits level using the brightness conversion data block 104, determine a brightness control signal directly compatible with a display device of the light source, and cause the light source of the display device to operate via a brightness control signal at a power level corresponding to operation of the light source in nits. For example, the memory resource 104 may store a number of sets of executable instructions that, when executed by the processor resource cause a basic input/output system (BIOS) to determine whether an extended display identification data (EDID) instance of a display source includes a nits-based detailed timing descriptor (DTD), and, generate a modified EDID instance with the brightness conversion data block 104 so that the modified EDID includes capabilities to convert the nits-based requests to native display signals of the display device, and cause the modified EDID instance to be provided to a video processor in lieu or in addition to the original EDID instance.

As described herein, the combination of circuitry and executable instructions may cause an electronic device to retrieve a first brightness characteristic and a second brightness characteristic associated with the light source in response to a request to operate a light source in nits, associate the first brightness characteristic with a first nits level and the second brightness characteristic with a second nits level using a brightness conversion data block, determine a brightness control signal directly compatible with a controller board of the light source based on an interpolation between the first nits level and the second nits level, and cause the light source to operate via the brightness control signal at a power level corresponding to the interpolation in response to the request to operate the light source in nits. This may be particularly helpful in industries that utilize high brightness accuracy and integrity, such as x-ray imagery and gaming.

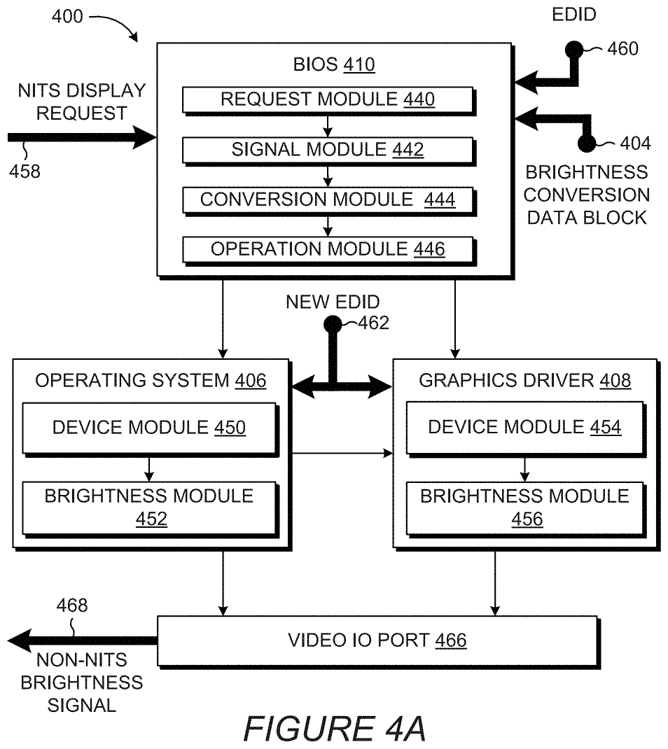

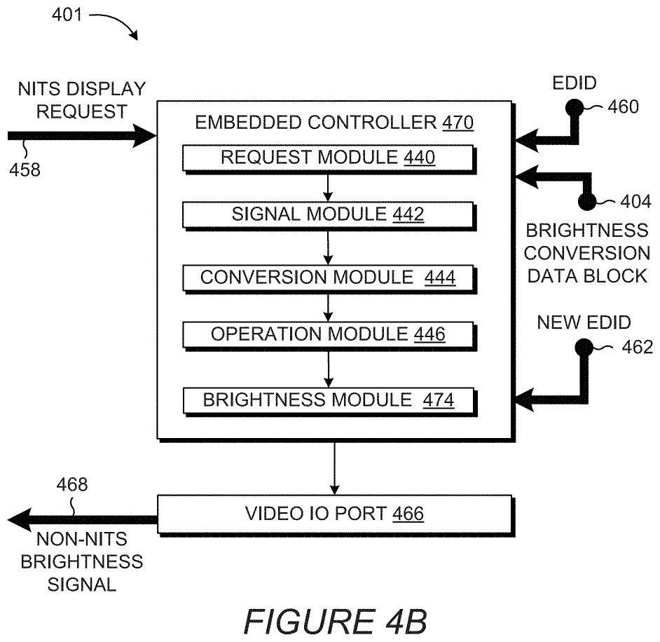

In some examples, functionalities described herein in relation to any of FIGS. 1-3 may be provided in combination with functionalities described herein in relation to any of FIGS. 4-11.

FIG. 2 depicts the example system 200 may comprise a memory resource 220 operatively coupled to a processor resource 222. Referring to FIG. 2, the memory resource 220 may contain a set of instructions that are executable by the processor resource 222. The set of instructions are operable to cause the processor resource 222 to perform operations of the system 200 when the set of instructions are executed by the processor resource 222. The set of instructions stored on the memory resource 220 may be represented as a request module 212, a conversion module 214, a signal module 216, and an operation module 218. The request module 212, the conversion module 214, the signal module 216, and the operation module 218 represent program instructions that when executed cause function of the system 200, which is the same function as system 100 of FIG. 1. Further examples regarding the modules 212, 214, 216, and 218 are provided with respect to description of FIG. 4. The processor resource 222 may carry out a set of instructions to execute the modules 212, 214, 216, 218, and/or any other appropriate operations among and/or associated with the modules of the system 200.

For example, the processor resource 222 may carry out a set of instructions to retrieve brightness parameters from a memory resource of a display source, use the brightness parameters to create a brightness conversion data block between nits and brightness control levels directly operational with a controller board of the display source, generate a modified instance of a display metadata format with the brightness conversion data block, provide the modified instance to an operating system or graphics driver via a configuration interface, and in response to receiving nit-based brightness input, cause the graphics driver to operate using the modified instance to drive a display panel of the display source to a brightness represented by an analog signal, such as a PWM signal or a direct voltage signal corresponding to the nit-based brightness input.

For another example, the processor resource 222 may carry out a set of instructions to cause a sensor to measure an emission level of an area of the display panel, update the brightness conversion data block using the measured emission level, and, determining a graphics function call is a nits-based type brightness function call corresponding to adaptive color function or adaptive brightness response function that uses an ambient light sensor.

For yet another example, the processor resource 222 may carry out a set of instructions to update the brightness conversion data block to compensate for brightness loss over time using a degradation estimation, and cause the video processor to use the modified EDID instance to execute a nits-based graphics function call via a graphics processing unit (GPU) using PWM signal to the display source and/or provide the modified EDID instance to an operating system to handle function calls to integrated graphics circuitry (based on which component is driving the panel during the active session).

In yet another example, the processor resource 222 may carry out a set of instructions to retrieve brightness parameters (including a DTD block corresponding to a minimum luminance value and a maximum luminance value) from a display source, and generate a modified EDID instance with includes a modified DTD as a Consumer Technology Association (CTA) block including a base nit level with a corresponding base PWM value (corresponding to the minimum luminance value), an auxiliary nit level with a corresponding auxiliary PWM value (to represent the maximum luminance value); and a relationship factor used to interpolate a PWM value between the base nit level and the auxiliary nit level.

Although these particular modules and various other modules are illustrated and discussed in relation to FIG. 2 and other example implementations, other combinations or sub-combinations of modules may be included within other implementations. Said differently, although the modules illustrated in FIG. 2 and discussed in other example implementations perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules. FIGS. 4A & 4B depict yet other examples of how functionality may be organized into modules.

A processor resource is any appropriate circuitry capable of processing (e.g., computing) instructions, such as one or multiple processing elements capable of retrieving instructions from a memory resource and executing those instructions. For example, the processor resource 222 may be a central processing unit (CPU) that enables brightness conversion by fetching, decoding, and executing modules 212, 214, 216, and 218. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the system 200. The medium is any non-transitory medium or combination of non-transitory media able to electronically store data, such as modules of the system 200 and/or data used by the system 200. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be said to store program instructions that when executed by a processor resource cause the processor resource to implement functionality of the system 200 of FIG. 2. A memory resource may be integrated in the same device as a processor resource or it may be separate but accessible to that device and the processor resource. A memory resource may be distributed across devices.

In FIG. 2, the executable instructions may be processor-executable instructions, such as program instructions, stored on the memory resource 220, which is a tangible, non-transitory computer-readable storage medium, and the circuitry may be electronic circuitry, such as processor resource 222, for executing those instructions. The instructions residing on a memory resource may comprise any set of instructions to be executed directly (such as machine code) or indirectly (such as a script) by a processor resource.

In some examples, the system 200 may include the executable instructions may be part of an installation package that when installed may be executed by a processor resource to perform operations of the system 200, such as methods described with regards to FIGS. 4A, 4B, and 7-11. In that example, a memory resource may be a portable medium such as a compact disc, a digital video disc, a flash drive, or memory maintained by a computer device, such as a web server, from which the installation package may be downloaded and installed. In another example, the executable instructions may be part of an application or applications already installed. A memory resource may be a non-volatile memory resource such as read-only memory (ROM), a volatile memory resource such as random-access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid-state drive (SSD), or an optical drive.

FIG. 3 depicts example environments in which an example brightness conversion system 300 may be implemented. The system 300 (described herein with respect to FIGS. 1 and 2) may represent generally any circuitry or combination of circuitry and executable instructions to cause modification of display metadata to allow for display functions that utilize nits-based operations. The example environment includes an electronic device 302 and a display device 330. The electronic device 302 may be the same as the electronic device 102 of FIG. 1. The display device 330 is operatively coupled to the electronic device 302. For example, a link may exist between the electronic device 302 and 330 to provide an electrical communication channel. A link generally represents one or a combination of a cable, wireless connection, fiber optic connection, or remote connections via a telecommunications link, an infrared link, a radio frequency link, or any other connectors of systems that provide electronic communication. The link may include, at least in part, intranet, the Internet, or a combination of both. The link may also include intermediate proxies, routers, switches, load balancers, and the like.

The electronic device 302 may include a video processor 324 separate from the processor resource 322. For example, a brightness characteristic may be retrieved from a host compute device, a display device, or a sensor; and a processor resource causes the light source to operate via a graphics driver. In other examples, the video processor 324 may be the same as processor resource 322, such as in the example of integrated graphics circuitry. A video processor 324 may be a graphics processing unit (GPU), an embedded controller, super 10 circuitry, and the like (e.g., any circuitry with a PWM or voltage output to control the panel's backlight or brightness). In some examples the video processor 324 may be distributed on a separate device, such as part of scaler circuitry integrated in the display device 330. In some examples, the embedded controller (or super 10 circuitry) may intercept the nit-based brightness request from the OS and drive the corresponding PWM signal (or direct voltage level signal) to the panel to achieve nit-based brightness control of the panel. For example, a privacy panel may be driven by an embedded controller in privacy mode and, the embedded controller may intercept the nit-based brightness control request to the OS so that operation of the privacy panel is changed according to the brightness conversion data block. In this manner, some example implementations may utilize a direct side channel to operate the display output rather than via the OS and/or graphics driver. For example, a side channel via an embedded controller may be used to communicate with the display panel rather than using an advanced configuration and power interface (ACPI) method via a display data channel (DDC).

The example display device 330 of FIG. 3 includes a memory resource 340, a controller board 342, a light source 344, a sensor 346, and a display panel 348. The light source 344 may be a backlight, a light emitting diode (LED), a plurality of light emitters corresponding to a number of pixels, and the like. The light source 344 may be used to provide illumination to a display panel 348 to present visual output imagery. In some examples, the light source is integrated in the display device. The display device may include standard dynamic range (SDR) circuitry having a timing controller without a nit-based brightness feature (or nit-based instruction set), or high dynamic range (HDR) circuitry having a timing controller without a nit-based brightness feature (or nit-based instruction set).

The controller board 342 represents circuitry corresponding to controlling the light source 344. The controller board 342 may operate using a type of signal directly compatible with the display panel 348. The memory resource 340 may contain EDID information 360 that corresponds to display characteristics, such as a range of luminosities operable by the light source 344 identified during factory tests. By using a modified EDID information, such as an instance of EDID information 360 updated with a nits-based brightness conversion data block, the display panel 348 may be illuminated to a nits level identified by a host device system (e.g., electronic device 302) by providing an equivalent light source illumination via a signal compatible with the controller board 342.

The sensor 346 may generate signals corresponding to environmental lighting data. For example, the sensor 346 may be an ambient light sensor (ALS). The sensor 346 may be used by nits-based display function calls performed on a host device to provide adaptive display features, such as an adaptive color function or an adaptive brightness response function. In other examples, the sensor 346 may be used to observe the range of luminosity of the light source 344 and update the brightness conversion data block and/or EDID 360 based on any changes to luminosity potential of the display device 330 (e.g., compensate for degradation of LEDs over time by using a sensor to update/confirm characteristics of the light source 344).

Referring to FIGS. 1-3, the components of systems 100, 200, and 300 (e.g., such as the modules 212, 214, 216, and 218 of FIG. 2) may be distributed across devices host devices, peripheral devices, or a combination thereof. Although the various components are shown as separate (e.g., such as modules 212-218) in FIGS. 1 and 2, in other implementations, the functionality of multiple engines and/or modules may be implemented as a single engine and/or module or divided in a variety of engines and/or modules. In some example, the components of the system 300 may perform example methods described in connection with FIGS. 4A, 4B, and 7-11.

FIGS. 4A & 4B depict example components useable to implement example brightness conversion systems 400 and 401. Referring to FIG. 4A, the example components of the example brightness conversion system 400 generally include a basic input/output system (BIOS) 410, an OS 406 and/or a graphics driver 408, and a video IO port 466. The example components of FIG. 4A may be implemented on a compute device, such as a mobile host device (e.g., a notebook computer).

The BIOS 410 represents a combination of circuitry and executable instructions to perform a boot up process for a host device and manage transfer of control of the host device to an OS. For example, the BIOS 410 may be a combination of a processor resource and executable instructions on the master boot record to cause initialization of the computer and IO capabilities thereof. As used herein, a BIOS encompasses Unified Extensible Firmware Interface (UEFI) systems.

The BIOS 410 includes program instructions (such as a request module 440, a conversion module 442, a signal module 444, and an operation module 446) to assist operation of a display device. The BIOS 410 during power-on self-test (POST) and/or in response to a nits-based display request 458, the execution of the system 400 causes retrieval of EDID 460 from memory of a display device coupled to the host device (e.g., via video IO port 466) and modification of the EDID 460 into a modified EDID 462 for use by the OS 406 or graphics diver 408.

The request module 440 represents program instruction that when executed cause a processor resource to cause retrieval of the EDID 460. For example, execution of request module 440 may cause a processor resource to send a signal to request access to memory of a display device where the EDID 460 is stored and cause the EDID 460 to be sent to a host device. Execution of the request module 440 may also identify whether EDID 460 includes a nit-based descriptor to support nits-based function calls by the OS 406 and/or graphics driver 408.

The signal module 442 represents program instructions that when executed cause a processor resource to determine a direct driving protocol of the display panel of the display device associated with the EDID 460. For example, the display panel may be driven by direct voltage or by PWM. Execution of the signal module 442, in conjunction with the conversion module 444, may cause identification of a range of luminosities driveable on the panel that correspond to a range of nits levels.

The conversion module 444 represents program instructions that when executed cause a processor resource to generate a brightness conversion data block 404 for the display device represented by the EDID 460. For example, execution of the conversion module 444 may cause a processor resource to identify the luminosity range described by EDID 460, generate a nits conversion to that luminosity range, and generate a brightness conversion data block 404 that converts nits-based functions into display device instructions based on execution of the signal module 442.

The operation module 446 represents program instructions that when executed cause a processor resource to generate a signal to cause operation of a display device via an OS 406 or graphics driver 408 using the modified EDID 462. For example, execution of the operation module 446 and the conversion module 444 may cause a brightness conversion data block 404 to be added to the EDID 460 to generate a new EDID 462, and prepare an instruction to the OS 406 and/or graphics driver 408 to cause a signal to the display device to illuminate to a corresponding nits level.

Depending on the computing environment, the OS 406 and/or the graphics driver 408 may handle management of display output (e.g., depending on whether the host device has integrated graphics circuitry or dedicated graphics circuitry). For example, the BIOS 410 may utilize an ACPI method via a DDC to provide the new EDID 462 to the OS 406 and/or graphics driver 408. The example system 400 of FIG. 4A depicts that the video IO port 466 may cause a panel instruction (e.g., non-nits brightness signal 468) based on instructions from the graphics driver 408, from the OS 406, or some combination of request, such as where the OS 406 receives and transfers a nit-based brightness request to the graphics driver 408, which causes the non-nits brightness signal 468 to be sent via the video IO port 466.

The OS 406 may include program instructions, such as a device module 450 and a brightness module 452, to prepare an instruction to a display device, such as an external monitor or integrated display panel. The device module 450 represents program instructions to identify the display device to receive the 10 output signal. Execution of the device module 450 may determine whether to use the original EDID 460 or the new EDID 462, such as based on the resources used by the system call of the OS (e.g., such ALS data). The brightness module 452 represents program instructions to determine an instruction for a light source to emit light at a brightness level based on the brightness conversion data block in response to request 458 for nits-based display operation. The graphics driver 408 may include program instructions, such as device module 454 and brightness module 456, that are the same as device module 450 and brightness module 452 of the OS 406.

The video IO port 466 may be a standard video output port, such as video graphics array (VGA), high-definition multimedia interface (HDMI), DisplayPort, etc. The graphics driver 406 may cause a signal 468 to be provided via the video IO port 466 to cause a display device to operate a light source accordingly. The non-nits brightness signal 468 represents an instruction, in a non-nits display-native instruction set, to cause the display device to operate at a brightness level corresponding to the nits-based request 458. For example, the display device may operate using an analog, direct voltage or PWM signal and the non-nits brightness signal 468 may be in a corresponding form useable with direct voltage or PWM to directly drive the display device. In this manner, the display device can be driven in accordance with nit-based requests even when the display device is unable to be directly driven using nits-based requests.

Referring to FIG. 4B, the example components of the example brightness conversion system 401 generally include an embedded controller 470 and a video IO port 466. The example components of FIG. 4B may be implemented on a compute device, such as a mobile host device (e.g., a notebook computer). The example system 401 includes similar modules as depicted with example system 400 of FIG. 4A, and, for brevity, their descriptions are not repeated in their entirety. For example, the brightness module 474 of FIG. 4B has similar functionality as brightness modules 452 and 456 of FIG. 4A. In that respect, the functions described with respect to the BIOS 410, OS 406, and graphics driver 408 of FIG. 4A are included in the embedded controller 470 of FIG. 4B. The difference of system 401 of FIG. 4B compared to system 400 of FIG. 4A is that the embedded controller 470 includes the brightness conversion system functionality and directly sends signals compatible with a display device via the video IO port 466. Because the embedded controller 470 is specifically programmed to control the display device, the system 401 may directly send a brightness control signal 468 via the video IO port 466 (e.g., without the intervention of the OS or graphics driver). In that example, the system 401 may generate the new modified EDID 462 or directly request the modified EDID 462 in preparation for generating the display device driving signal 468.

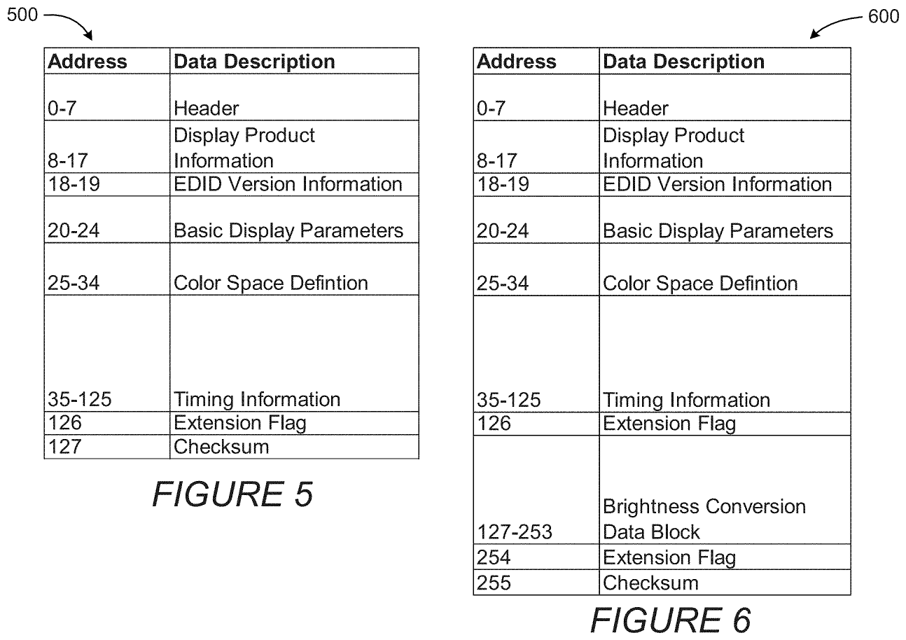

FIGS. 5 and 6 depict examples of display metadata 500 and 600, such as in the format of EDID. The table of FIG. 5 depicts an example set of address and corresponding data description of an EDID instance from a display device. The size of the example EDID instance of FIG. 5 is 128 bytes. The table of FIG. 6 depicts an example of a modified instance of the EDID instance of FIG. 5, where the table of FIG. 6 includes a 128-byte extension, in which is included the brightness conversion data block. In this manner, the modified EDID instance of FIG. 6 is of a size of 256 bytes.

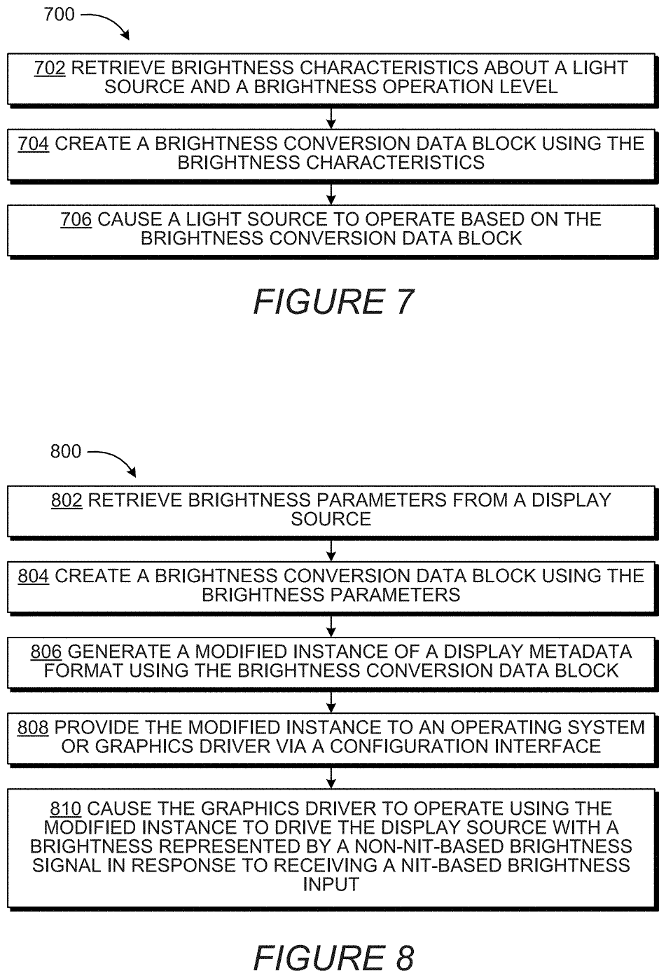

FIGS. 7-11 are flow diagrams depicting example methods of causing operation of a display device. Referring to FIG. 7, example method 700 of causing operation of a display device may generally comprise creating a brightness conversion data block from brightness characteristics and causing a light source to operate using the brightness conversion data block. The method 700 is performable by the system 100 of FIG. 1.

At block 702, brightness control characteristics about a light source are retrieved using a processor resource. A brightness operation level may be retrieved by the processor resource as well. For example, the maximum and minimum brightness of a display device may be retrieved, as well as a receive a nits-level of brightness at which to operate a display device. The information may be retrieved by accessing memory of the display device for stored display metadata.

At block 704, a brightness conversion data block is created by a processor resource using the brightness characteristics retrieved at block 702. The brightness conversion data block may include a number of non-nit brightness levels corresponding to nits brightness levels. For example, the minimum brightness level in nits and the maximum brightness level in nits as well as a slope factor between the two points may be part of the brightness conversion data block, as derived from the original EDID of the display device.

At block 706, a light source is caused, via a processor resource, to operate based on the brightness conversion data block. In other words, the brightness conversion data block may be used to convert a nits-based display operation incompatible with the display device to a non-nits-based display operation compatible with the display device.

FIG. 8 includes blocks similar to blocks of FIG. 7 and provides additional blocks and details. In particular, FIG. 8 depicts additional blocks and details generally regarding generating a modified instance of display metadata with a brightness conversion data block and using the modified display metadata with the brightness conversion block. Blocks 802 and 804 are the same as blocks 702 and 704 of FIG. 7 and, for brevity, their respective descriptions are not repeated. The method 800 is performable by the system 100 of FIG. 1.

At block 806, a modified instance of display metadata format (e.g., a modified instance of original EDID of the display device) is generated by a processor resource using the brightness conversion data block created at block 804 using parameters retrieved at block 802.

At block 808, the modified instance is provided by a processor resource to an OS or a graphics driver via a configuration interface, e.g., such as ACPI and/or DDC. The graphics driver is caused to operate using the modified instance to drive the display source. In this manner, the display source may be driven using a brightness represented by a non-nit-based brightness signal in response to a receiving a nit-based brightness input.

At block 810, the graphics driver is caused, via a processor resource, to operate using the modified instance of display metadata (including the brightness conversion data block). For example, the graphics driver may drive the display source with a brightness represented by a non-nit based brightness signal in response to receiving a nit-based brightness input from a system on the host device (e.g., making a request to the OS or graphics driver of the host device).

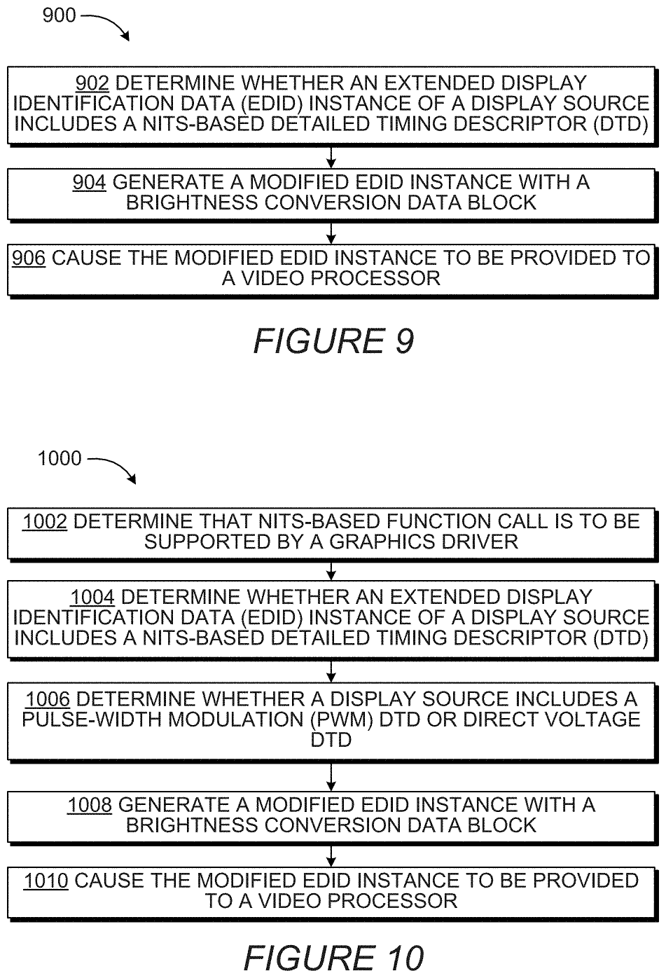

Referring to FIG. 9, example method 900 of causing operation of a display device may generally comprise determining whether a display source has nits-based operation capabilities, generating a modified display metadata instance with a brightness conversion data block, and causing the modified display metadata instance to be provided to a video processor. The method 900 is performable by the system 100 of FIG. 1.

At block 902, a determination is made by a processor resource as to whether an EDID instance of a display source includes a nits-based DTD. For example, a processor resource executing a BIOS may determine whether EDID instance of a display source includes a nits-based DTD.

At block 904, a modified EDID instance is generated, by a processor resource, with a brightness conversion data block. For example, a processor resource executing a BIOS may generate a modified EDID instance based on a PWM DTD retrieved from a display source.

At block 906, the modified EDID instance is to be provided by a processor resource to a video processor. For example, a processor resource executing a BIOS may cause the modified EDID instance to be provided to a GPU. Example video processors include a GPU, an embedded controller, or any other circuitry capable of outputting a PWM or voltage level to drive a display device.

FIG. 10 includes blocks similar to blocks of FIG. 9 and provides additional blocks and details. In particular, FIG. 10 depicts additional blocks and details generally regarding performing elements of FIG. 9 in response to determinations. Blocks 1004, 1008, and 1010 are the same as blocks 902, 904, and 906 of FIG. 9 and, for brevity, their respective descriptions are not repeated. The method 1000 is performable by the system 100 of FIG. 1.

At block 1002, a determination is made by a processor resource as to whether a nits-based function call is to be supported by a graphics driver. Block 1004 may be performed in response to operations performed at block 1002.

At block 1006, a determination is made by a processor resource as to whether an EDID of a display source includes a PWM DTD or direct voltage DTD. Block 1006 may be performed in response to operations performed at block 1004, such as in response to a determination that the display source accepts PWM signals and the graphic function to be supported is nits-based.

At block 1010, the generated modified EDID instance with a brightness control block is caused, via a processor resource, to be provided to a video processor, such as in response to a determination that the display source includes a PWM DTD and the graphic function to be supported is nits-based.

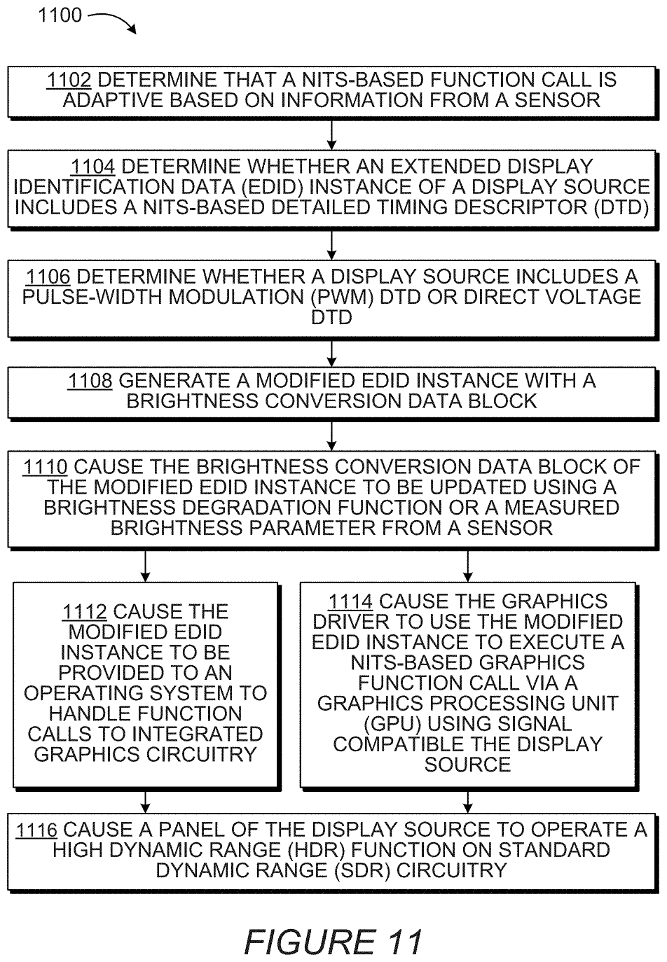

Referring to FIG. 11, example method 1100 of causing operation of a display device may generally comprise determining an adaptive nits-based function call is to be supported, determine whether an EDID includes nits-based function support, generating a modified EDID instance with a brightness conversion data block to convert the nits-based request into a request acceptable by a display device, update the brightness conversion data block based on a degradation function, provide the modified EDID instance with updated brightness conversion block to an OS or graphics driver, and causing a panel of ta display source to operate in an HDR range to a nits level based on the brightness conversion data block. The method 1100 is performable by the system 300 of FIG. 3.

At block 1102, a type of function to be supported is determined by a processor resource. If the type of function is to be adaptive based on sensor information, then a nits-based function may need to be supported by a display device. Indeed, the method 1100 may be initiated by determining a graphics function call is a nits-based type brightness function call corresponding to adaptive color function or adaptive brightness response function that uses data generated from an ambient light sensor. At block 1104, a determination is made as to whether an EDID instance of a display source includes a nits-based DTD. If none, then the processor resource executing the method 1100 determines to create support by generating a modified EDID instance with a brightness conversion data block based on the manner at which the display source accepts signals as determined at block 1106 (e.g., direct voltage or PWM).

At block 1110, the brightness conversion data block of the modified EDID instance is caused to be updated by a processor resource. The brightness conversion data block may be updated using a brightness degradation function (e.g., a function that describes likely degradation of a light source over time) or a measured brightness parameter from a sensor, such an ALS sensor. The updated modified EDID instance is then provided by a processor resource to the component to manage visual output.

At block 1112, the modified EDID instance is caused, by a processor resource, to be provided to an OS to handle function calls to integrated graphics circuitry. In some examples, as discussed herein, the OS processes the nits-based function request and passes the nits-based function request to the graphics driver for further processing with the brightness conversion data block.

At block 1114, the graphics driver is caused, by a processor resource, to use the modified EDID instance to execute a nits-based graphics function call via a GPU using a signal compatible with the display source, such as a PWM signal.

At block 1116, a panel of the display source is caused to operate an HDR function on SDR circuitry using the brightness conversion data block of the modified EDID instance. By providing an update to the EDID information that correlates the input type and the output instructions acceptable to the display device, the display device may be able to perform functions of new technologies without a firmware update.

Although the flow diagrams of FIGS. 4A, 4B, and 7-11 illustrate specific orders of execution, the execution order may differ from that which is illustrated. For example, the execution order of the blocks may be scrambled relative to the order shown. Also, the blocks shown in succession may be executed concurrently or with partial concurrence. All such variations are within the scope of the present description.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature described as based on some stimulus may be based only on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

1. An electronic device comprising:
a processor resource;
a memory resource, the memory resource comprising a set of instructions executable by the processor resource to:
retrieve a first brightness characteristic and a second brightness characteristic associated with a light source in response to a graphics function call that is a nits-based type brightness function call that includes a particular nits level;
associate the first brightness characteristic with a first nits level and the second brightness characteristic with a second nits level using a brightness conversion data block;
determine a brightness control signal directly compatible with a controller board of the light source based on an interpolation between the first nits level and the second nits level; and
cause the light source to operate via the brightness control signal at a power level corresponding to the interpolation of the particular nits level of the nits-based type brightness function call.

2. The electronic device of claim 1, wherein:
the brightness conversion data block is generated from:
a base nit level with a corresponding base pulse-width modulation (PWM) value or base voltage level value; and
an auxiliary nit level with a corresponding auxiliary PWM value or auxiliary voltage level value.

2. The electronic device of claim 2, wherein:
the brightness conversion data block is generated using a plurality of additional auxiliary nit levels and a relationship factor; and
the relationship factor includes:
a curve factor adapted to a minimum range of PWM values and a maximum range of PWM values; and
a linear factor outside of the minimum range of PWM values and the maximum range of PWM values.

3. The electronic device of claim 1, wherein:
the first brightness characteristic is retrieved from a host compute device, a display device, or a sensor; and
the processor resource is a graphics processing unit, the graphics processing unit to cause the light source to operate via a graphics driver.

4. The electronic device of claim 1, wherein:
the light source is integrated in a display device; and
the display device includes:
standard dynamic range (SDR) circuitry having a timing controller without a nit-based brightness feature, or
high dynamic range (HDR) circuitry having a timing controller without a nit-based brightness feature.

5. A non-transitory computer-readable storage medium (NTCRSM) comprising a set of instructions executable by a processor resource to:
retrieve brightness parameters from a memory resource of a display source in response to a graphics function call that is a nits-based type brightness function call that includes a particular nits level;
use the brightness parameters to create a brightness conversion data block between nits and brightness control levels directly operational with a controller board of the display source;
generate a modified instance of a display metadata format with the brightness conversion data block;
provide the modified instance to an operating system or graphics driver via a configuration interface; and
cause the graphics driver to operate using the modified instance to drive a display panel of the display source to a brightness represented by an analog signal corresponding to the nit-based brightness input of the particular nits level of the nits-based type brightness function call.

6. The NTCRSM of claim 6, wherein the set of instructions is executable by the processor resource to:
update the brightness conversion data block to compensate for brightness loss over time using a degradation estimation.

7. The NTCRSM of claim 6, wherein the set of instructions is executable by the processor resource to:
cause a sensor to measure an emission level of an area of the display panel; and
update the brightness conversion data block using the measured emission level.

8. The NTCRSM of claim 6, wherein:
the brightness parameters retrieved from the memory resource of the display source includes a detailed timing descriptor block (DTD) corresponding to a minimum luminance value and a maximum luminance value; and
a modified EDID instance that includes a modified DTD as a Consumer Technology Association (CTA) block, the modified DTD including:
a base nit level with a corresponding base pulse-width modulation (PWM) value, the base PWM corresponding to the minimum luminance value;
an auxiliary nit level with a corresponding auxiliary PWM value, the corresponding auxiliary PWM value to represent the maximum luminance value; and
a relationship factor, the relationship factor used to interpolate a PWM value between the base nit level and the auxiliary nit level.

9. A method of causing operation of a display device, the method comprising:
determining, via a processor resource executing a basic input output system (BIOS), whether an Extended Display Identification Data (EDID) instance of a display source includes a nits-based detailed timing descriptor (DTD) in response to a graphics function call that is a nits-based type brightness function call that includes a particular nits level;
in response to a determination that the display source includes a pulse-width modulation (PWM) DTD, generating via the processor resource executing the BIOS, a modified EDID instance with a brightness conversion data block, the PWM DTD to be retrieved from EDID instance of the display source; and
causing via the processor resource executing the BIOS, the modified EDID instance to be provided to a video processor that corresponds to the particular nits level of the nits-based type brightness function call.

10. The method of claim 10, comprising:
causing the video processor to use the modified EDID instance to execute a nits-based graphics function call via a graphics processing unit (GPU) using a PWM signal to the display source.

11. The method of claim 10, comprising:
providing the modified EDID instance to an operating system, the operating system to handle function calls to integrated graphics circuitry.

12. The method of claim 10, comprising:
causing the brightness conversion data block of the modified EDID instance to be updated using a brightness degradation function or a measured brightness parameter from a sensor.

14. The method of claim 10, comprising:
causing a panel of the display source to operate a high dynamic range (HDR) function on standard dynamic range (SDR) circuitry.

15. The method of claim 10, comprising:
determining a graphics function call is a nits-based type brightness function call corresponding to adaptive color function or adaptive brightness response function that uses an ambient light sensor.

16. The method of claim 10, wherein the nits-based type brightness function call is an operating system function call that utilizes a nits level.
